(19) United States
(12) Patent Application Publication
(10) Pub. No.: US 2026/0188567 A1
(43) Pub. Date: Jul. 2, 2026

(54) INDUCTOR STRUCTURE AND METHOD OF MANUFACTURING THE SAME

(71) Applicant: PHOENIX PIONEER TECHNOLOGY CO., LTD., Hsinchu County (TW)

(72) Inventor: Pao-Hung Chou, Hsinchu County (TW)

(21) Appl. No.: 19/430,791

(22) Filed: Dec. 23, 2025

(30) Foreign Application Priority Data
Dec. 26, 2024 (TW) 113150971

(51) Int. Cl. H01F 27/33; B23K 26/22; B23K 101/36; H01F 17/00; H01F 27/02; H01F 41/12; H01F 41/26

(52) U.S. Cl. CPC H01F 27/33; B23K 26/22; H01F 17/0033; H01F 27/022; H01F 41/127; H01F 41/26; B23K 2101/36; H01F 2017/008; H01F 2017/0086

(57) ABSTRACT

An inductor structure is provided and includes at least two welding pads, a winding spiral coil, and a cladding layer. The winding spiral coil is disposed on upper surfaces of the at least two welding pads, and two endpoints of the winding spiral coil are electrically connected to the at least two welding pads, respectively. The cladding layer covers the winding spiral coil and the at least two welding pads, and lower surfaces of the at least two welding pads are exposed from the cladding layer. A method of manufacturing the inductor structure is further provided.

### CROSS-REFERENCE TO RELATED APPLICATIONS

This Application claims the benefit of priority to Taiwan Patent Application No. 113150971 filed on Dec. 26, 2024 in Taiwan, the entire contents of which are incorporated herein by reference.

### BACKGROUND

### 1. Technical Field

The present disclosure relates to an inductor, and more particularly, to an inductor structure that suppresses generate noise under high-current/high-frequency operations and a manufacturing method thereof.

### 2. Description of Related Art

As shown in FIG. 1, a conventional inductive element 1 has a coil 10 embedded in an insulating material 11, and two terminals of the coil 10 are respectively connected to electrodes 12. In addition, the electrodes 12 are bent and affixed to side and bottom surfaces of the insulating material 11. However, when the exposed electrodes 12 are not tightly attached to the insulating material 11, noise will be generated under high-current/high-frequency operations.

Therefore, how to overcome various problems of the above-mentioned prior art has become a pressing technical issue in the industry.

### SUMMARY

The present disclosure provides a method of manufacturing an inductor structure, and the method comprises: forming at least two welding pads on a carrier board by electroplating by means of a patterned exposure and development process; disposing a winding spiral coil on upper surfaces of the at least two welding pads, wherein two endpoints of the winding spiral coil are electrically connected to the at least two welding pads, respectively, and a body of the winding spiral coil is formed of a copper wire or a copper alloy wire; forming a cladding layer on the carrier board to cover the winding spiral coil and the at least two welding pads; and removing the carrier board to expose lower surfaces of the at least two welding pads from the cladding layer.

In the aforementioned method of manufacturing the inductor structure, after forming the at least two welding pads by electroplating and before disposing the winding spiral coil, another patterned exposure and development process is performed to form a vertically oriented magnetic pillar on the carrier board and in a region between the at least two welding pads by electroplating.

In the aforementioned method of manufacturing the inductor structure, after forming the at least two welding pads by electroplating and before disposing the winding spiral coil, a first insulating layer covering the carrier board and the at least two welding pads is first formed, and a portion of the first insulating layer is then removed to expose the upper surfaces of the at least two welding pads.

In the aforementioned method of manufacturing the inductor structure, after forming the first insulating layer and exposing the upper surfaces of the at least two welding pads, another patterned exposure and development process is subsequently performed to form a vertically oriented magnetic pillar on the first insulating layer and in a region between the at least two welding pads by electroplating.

In the aforementioned method of manufacturing the inductor structure, after forming the magnetic pillar, the winding spiral coil is disposed on the upper surfaces of the at least two welding pads and the first insulating layer, the winding spiral coil encircles the magnetic pillar, a second insulating layer is subsequently formed on the upper surfaces of the at least two welding pads and the first insulating layer to cover the winding spiral coil and the magnetic pillar, and the first insulating layer and the second insulating layer jointly serve as the cladding layer.

In the aforementioned method of manufacturing the inductor structure, the cladding layer is made of a magnetic insulating material.

In the aforementioned method of manufacturing the inductor structure, after removing the carrier board, a surface treatment process is performed to form a surface treatment layer on the lower surfaces of the at least two welding pads.

In the aforementioned method of manufacturing the inductor structure, the method further comprises respectively fixing the two endpoints of the winding spiral coil to the upper surfaces of the at least two welding pads by welding by means of a laser spot welding process.

The present disclosure further provides an inductor structure, which comprises: at least two welding pads, wherein each of the at least two welding pads has an upper surface and a lower surface opposing the upper surface; a winding spiral coil disposed on the upper surfaces of the at least two welding pads, wherein two endpoints of the winding spiral coil are electrically connected to the at least two welding pads, respectively, and a body of the winding spiral coil is formed of a copper wire or a copper alloy wire; and a cladding layer covering the winding spiral coil and the at least two welding pads, wherein the lower surfaces of the at least two welding pads are exposed from the cladding layer.

In the aforementioned inductor structure, the present disclosure further comprises: a magnetic pillar embedded within the cladding layer and vertically disposed between the at least two welding pads, wherein the winding spiral coil encircles the magnetic pillar.

In the aforementioned inductor structure, one end surface of the magnetic pillar is exposed from the cladding layer.

In the aforementioned inductor structure, the cladding layer comprises a first insulating layer and a second insulating layer, the first insulating layer covers the at least two welding pads, the upper surfaces and the lower surfaces of the at least two welding pads are exposed from the first insulating layer, and the second insulating layer is formed on the first insulating layer and covers the winding spiral coil.

In the aforementioned inductor structure, the present disclosure further comprises: a magnetic pillar embedded within the second insulating layer and vertically disposed on the first insulating layer, wherein the winding spiral coil encircles the magnetic pillar.

In the aforementioned inductor structure, the present disclosure further comprises: a surface treatment layer formed on the lower surfaces of the at least two welding pads.

In the aforementioned inductor structure, the cladding layer is made of a magnetic insulating material.

In summary, the inductor structure and its manufacturing method of the present disclosure can enable the winding spiral coil and the welding pads to be covered in a magnetic insulating material. The resulting inductor structure does not generate noise under high-current/high-frequency operations. In addition, the inductance/resistance values can be adjusted by selecting suitable types of winding spiral coil (e.g., copper wire) for winding according to requirements, thereby facilitating various designs and applications.

### BRIEF DESCRIPTION OF THE DRAWINGS

FIG. 1 is a schematic cross-sectional view of a conventional inductive element.

FIG. 2A to FIG. 2E are schematic cross-sectional views illustrating a manufacturing method of an inductor structure according to a first embodiment of the present disclosure.

FIG. 3A to FIG. 3F are schematic cross-sectional views illustrating a manufacturing method of an inductor structure according to a second embodiment of the present disclosure.

FIG. 4A to FIG. 4F are schematic cross-sectional views illustrating a manufacturing method of an inductor structure according to a third embodiment of the present disclosure.

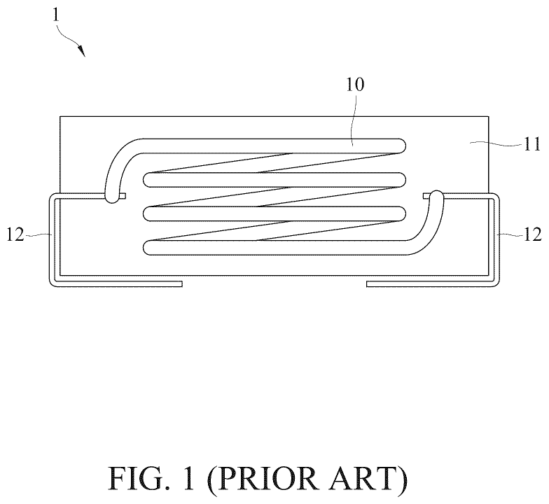

### DETAILED DESCRIPTION

The following describes the implementation of the present disclosure with examples. Those skilled in the art can easily understand other advantages and effects of the present disclosure from the contents disclosed in this specification.

It should be understood that the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable purposes should still be deemed as falling within the scope defined by the technical contents disclosed in the present specification. Meanwhile, terms such as “on,” “upper,” “lower,” “first,” “second,” “a,” “one,” “at least one,” “at least two,” and the like are for clear explanation rather than limiting the practicable scope of the present disclosure, and thus, alterations or adjustments of the relative relationships thereof without essentially altering the technical contents should still be considered within the practicable scope of the present disclosure.

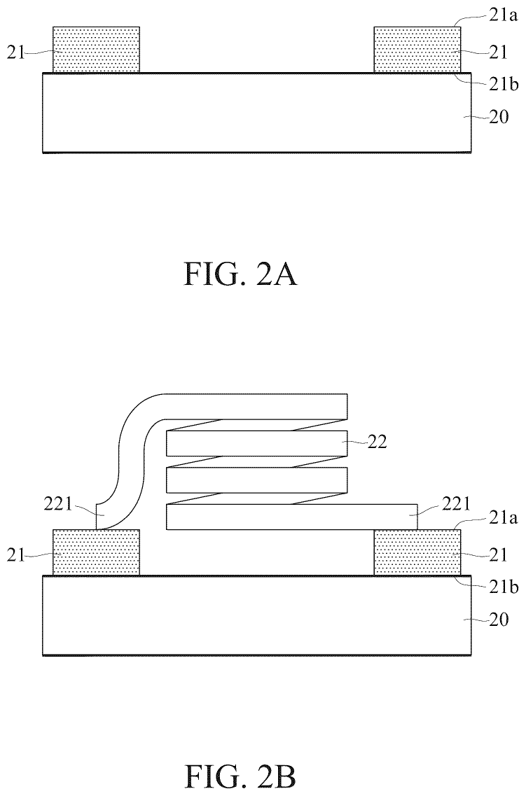

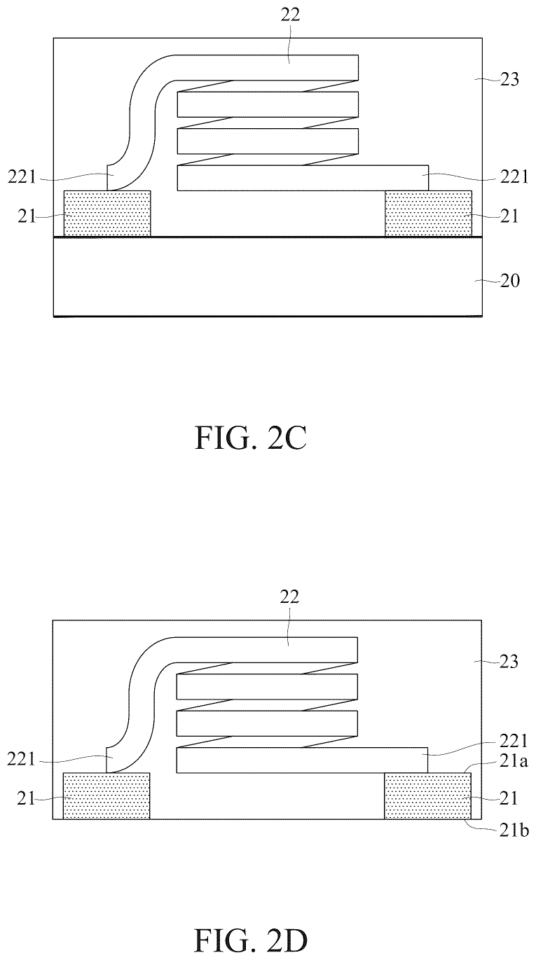

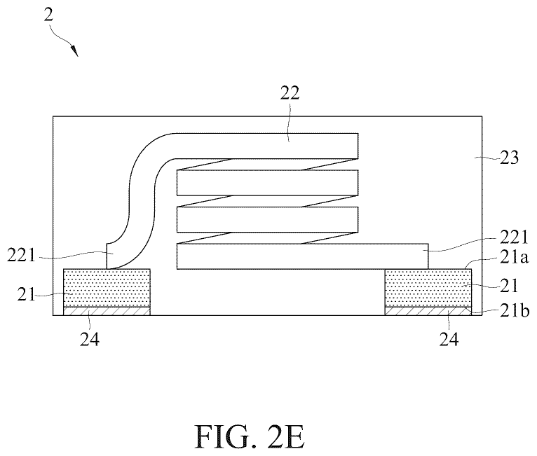

FIG. 2A to FIG. 2E are schematic cross-sectional views illustrating a manufacturing method of an inductor structure 2 according to a first embodiment of the present disclosure. The manufacturing method of the inductor structure 2 of the present disclosure employs an integrated circuit (IC) carrier board process.

As shown in FIG. 2A, a carrier board 20 is first provided. By means of a patterned exposure and development process, at least two welding pads 21 are formed on the carrier board 20 by electroplating.

The carrier board 20 is made of a semiconductor packaging carrier material, such as a rigid composite semiconductor packaging carrier material composed of an insulating material and a metallic material (e.g., stainless steel, copper, copper alloy, aluminum alloy, or combinations thereof), but the present disclosure is not limited as such.

Each of the welding pads 21 has an upper surface 21a and a lower surface 21b opposing the upper surface 21a, with the lower surface 21b disposed on the carrier board 20. Each of the welding pads 21 may, for example, be made of a metallic material such as copper or a solder material.

As shown in FIG. 2B, a winding spiral coil 22 is disposed on the upper surfaces 21a of the at least two welding pads 21.

The winding spiral coil 22 has two opposite endpoints 221, which are electrically connected to the at least two welding pads 21, respectively. In an embodiment, the two endpoints 221 of the winding spiral coil 22 are first disposed on the upper surfaces 21a of the at least two welding pads 21, respectively. Subsequently, by means of a laser spot welding process, the two endpoints 221 of the winding spiral coil 22 are respectively fixed to the upper surfaces 21a of the at least two welding pads 21 by welding.

Moreover, a body of the winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

As shown in FIG. 2C, a cladding layer 23 is formed on the carrier board 20 to cover the winding spiral coil 22 and the at least two welding pads 21.

The cladding layer 23 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

Furthermore, the cladding layer 23 is formed on the carrier board 20 by molding, coating, or lamination.

As shown in FIG. 2D, the carrier board 20 is removed to expose the lower surfaces 21b of the at least two welding pads 21 from the cladding layer 23.

As shown in FIG. 2E, a surface treatment process is performed to form a surface treatment layer 24 on the lower surfaces 21b of the at least two welding pads 21, followed by a singulation process to obtain the inductor structure 2 of the present disclosure.

The surface treatment layer 24 may be formed on the lower surfaces 21b of the welding pads 21 by electroplating. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the manufacturing method of the inductor structure of the present disclosure employs an IC carrier board process combined with a winding spiral coil. The winding spiral coil and the welding pads are both covered in the cladding layer to form an integrated structure. The resulting inductor structure does not generate noise under high-current/high-frequency operations. The inductance/resistance values can be adjusted by selecting suitable types of winding spiral coil (e.g., copper wire) for winding according to requirements, thereby facilitating various designs and applications.

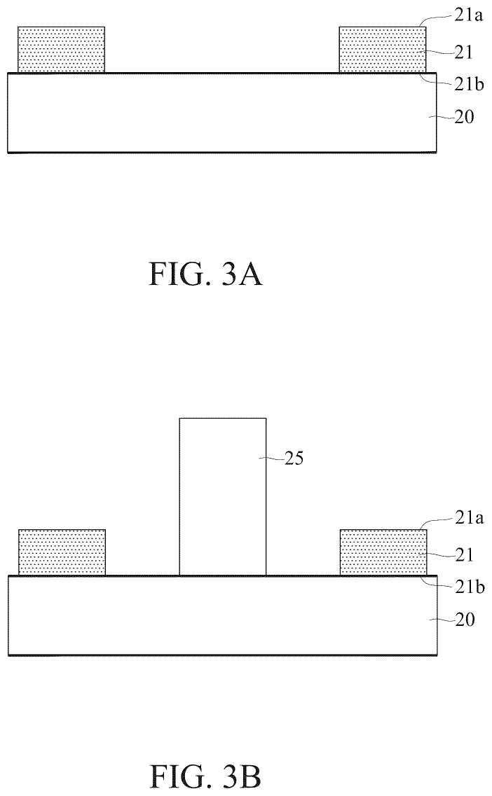

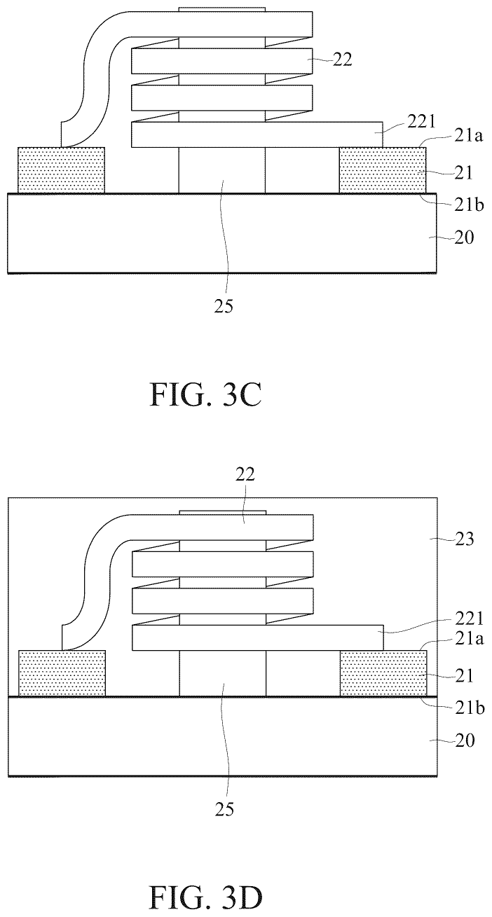

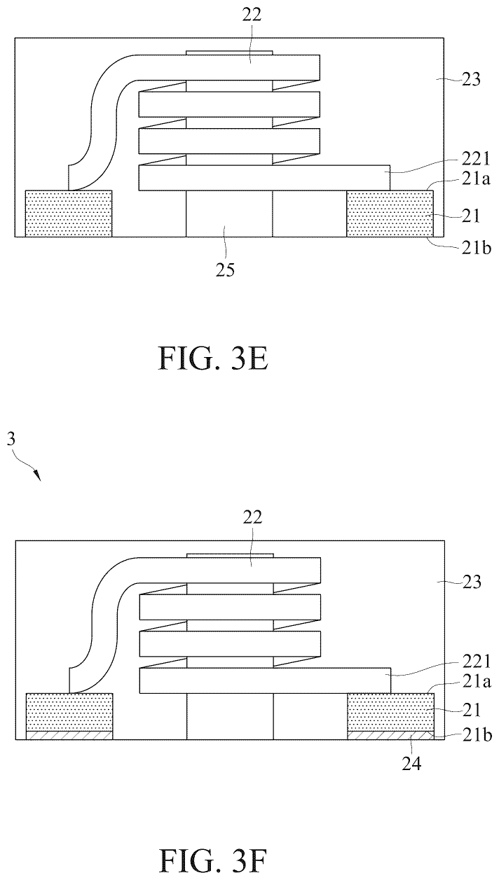

FIG. 3A to FIG. 3F are schematic cross-sectional views illustrating a manufacturing method of an inductor structure 3 according to a second embodiment of the present disclosure. The difference in technical contents between the second embodiment and the aforementioned first embodiment lies in the magnetic pillar 25, and the same technical contents will not be repeated hereafter.

As shown in FIG. 3A, a carrier board 20 is first provided. By means of a patterned exposure and development process, at least two welding pads 21 are formed on the carrier board 20 by electroplating.

The carrier board 20 is made of a semiconductor packaging carrier material, such as a rigid composite semiconductor packaging carrier material composed of an insulating material and a metallic material (e.g., stainless steel, copper, copper alloy, aluminum alloy, or combinations thereof), but the present disclosure is not limited as such.

Each of the welding pads 21 has an upper surface 21a and a lower surface 21b opposing the upper surface 21a, with the lower surface 21b disposed on the carrier board 20. Each of the welding pads 21 may, for example, be made of a metallic material such as copper or a solder material.

As shown in FIG. 3B, a patterned exposure and development process is performed to form a vertically oriented magnetic pillar 25 (e.g., magnetic-conductive pillar) on the carrier board 20 and in a region between the at least two welding pads 21 by electroplating.

The magnetic pillar 25 is of a pillar structure. The material of the magnetic pillar 25 may be a magnetically permeable material including at least one of iron (Fe), nickel (Ni), cobalt (Co), manganese (Mn), or zinc (Zn), or a combination thereof, or may be an alloy metal such as NiFe, NiSe, or CoNiFe.

As shown in FIG. 3C, a winding spiral coil 22 is disposed on the upper surfaces 21a of the at least two welding pads 21, and the winding spiral coil 22 encircles the magnetic pillar 25.

The winding spiral coil 22 has two opposite endpoints 221, which are electrically connected to the at least two welding pads 21, respectively. In an embodiment, the winding spiral coil 22 first encircles the magnetic pillar 25, and the two endpoints 221 of the winding spiral coil 22 are disposed on the upper surfaces 21a of the at least two welding pads 21, respectively. Subsequently, by means of a laser spot welding process, the two endpoints 221 of the winding spiral coil 22 are respectively fixed to the upper surfaces 21a of the at least two welding pads 21 by welding.

Moreover, a body of the winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

As shown in FIG. 3D, a cladding layer 23 is formed on the carrier board 20 to cover the winding spiral coil 22, the magnetic pillar 25, and the at least two welding pads 21.

The cladding layer 23 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

Furthermore, the cladding layer 23 is formed on the carrier board 20 by molding, coating, or lamination.

As shown in FIG. 3E, the carrier board 20 is removed to expose the lower surfaces 21b of the at least two welding pads 21 and one end surface of the magnetic pillar 25 from a lower surface of the cladding layer 23.

As shown in FIG. 3F, a surface treatment process is performed to form a surface treatment layer 24 on the lower surfaces 21b of the at least two welding pads 21, followed by a singulation process to obtain the inductor structure 3 of the present disclosure.

The surface treatment layer 24 may be formed on the lower surfaces 21b of the at least two welding pads 21 by electroplating. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the manufacturing method of the inductor structure of the present disclosure employs an IC carrier board process combined with a winding spiral coil. The winding spiral coil, the magnetic pillar, and the welding pads are covered in the cladding layer to form an integrated structure. The resulting inductor structure does not generate noise under high-current/high-frequency operations. The inductance/resistance values can be adjusted by selecting suitable types of winding spiral coil (e.g., copper wire) for winding according to requirements, thereby facilitating various designs and applications.

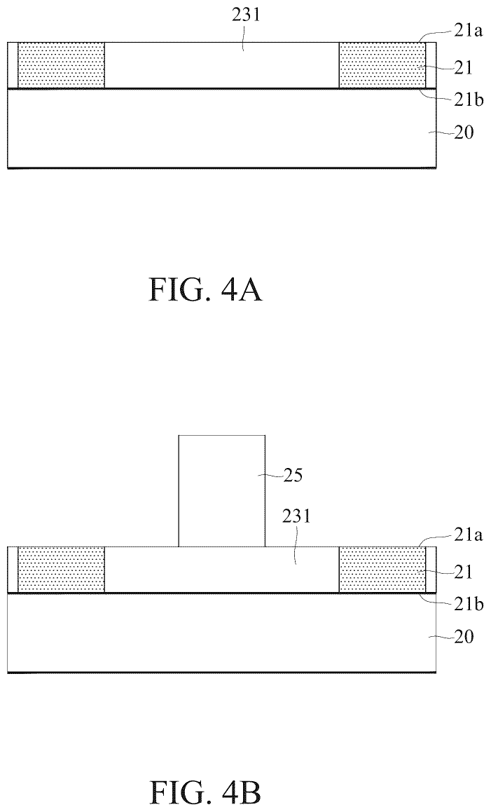

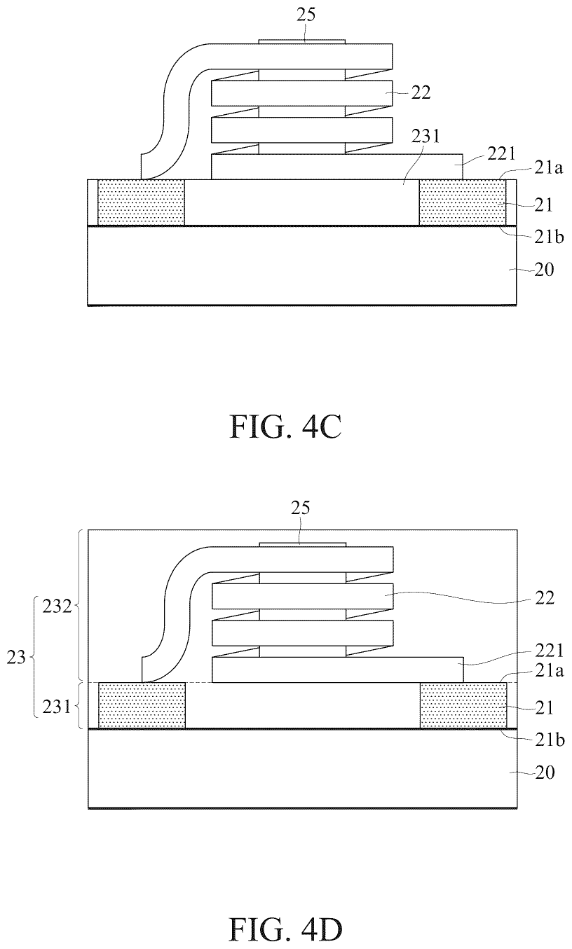

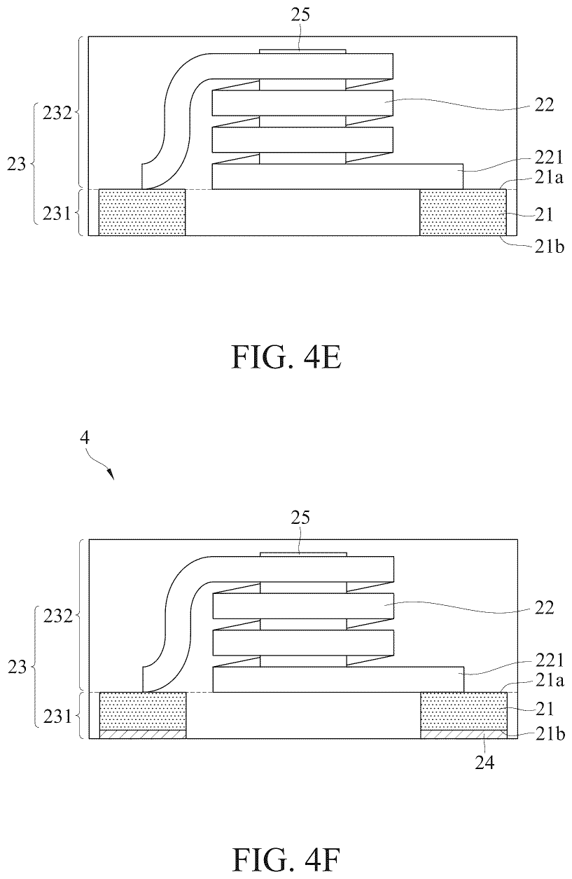

FIG. 4A to FIG. 4F are schematic cross-sectional views illustrating a manufacturing method of an inductor structure 4 according to a third embodiment of the present disclosure. The difference in technical contents between the third embodiment and the aforementioned first and second embodiments lies in the cladding layer 23, and the same technical contents will not be repeated hereafter.

As shown in FIG. 4A, a carrier board 20 is first provided. By means of a patterned exposure and development process, at least two welding pads 21 are formed on the carrier board 20 by electroplating. Subsequently, a first insulating layer 231 is formed on the carrier board 20. The first insulating layer 231 covers the carrier board 20 and the at least two welding pads 21. After that, a portion of the first insulating layer 231 is removed to expose the upper surfaces 21a of the at least two welding pads 21.

The carrier board 20 is made of a semiconductor packaging carrier material, such as a rigid composite semiconductor packaging carrier material composed of an insulating material and a metallic material (e.g., stainless steel, copper, copper alloy, aluminum alloy, or combinations thereof), but the present disclosure is not limited as such.

Each of the welding pads 21 has an upper surface 21a and a lower surface 21b opposing the upper surface 21a, with the lower surface 21b disposed on the carrier board 20. Each of the welding pads 21 may, for example, be made of a metallic material such as copper or a solder material.

The first insulating layer 231 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

The above embodiment illustrates the process by first forming the welding pads 21 and then forming the first insulating layer 231. However, the present disclosure is not limited as such. Alternatively, the first insulating layer 231 may be formed first, followed by forming the welding pads 21 within openings of the first insulating layer 231 by electroplating.

As shown in FIG. 4B, a patterned exposure and development process is performed to form a vertically oriented magnetic pillar 25 (e.g., magnetic-conductive pillar) on the first insulating layer 231 and in a region between the at least two welding pads 21 by electroplating.

The magnetic pillar 25 is of a pillar structure. The material of the magnetic pillar 25 may be a magnetically permeable material including at least one of iron (Fe), nickel (Ni), cobalt (Co), manganese (Mn), or zinc (Zn), or a combination thereof, or may be an alloy metal such as NiFe, NiSe, or CoNiFe.

As shown in FIG. 4C, a winding spiral coil 22 is disposed on the first insulating layer 231 and the upper surfaces 21a of the at least two welding pads 21, and the winding spiral coil 22 encircles the magnetic pillar 25.

The winding spiral coil 22 has two opposite endpoints 221, which are electrically connected to the at least two welding pads 21, respectively. In an embodiment, the winding spiral coil 22 is disposed on the first insulating layer 231 and encircles the magnetic pillar 25 first. Subsequently, the two endpoints 221 of the winding spiral coil 22 are disposed on the upper surfaces 21a of the at least two welding pads 21, respectively. After that, by means of a laser spot welding process, the two endpoints 221 of the winding spiral coil 22 are respectively fixed to the upper surfaces 21a of the at least two welding pads 21 by welding.

Moreover, a body of the winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

As shown in FIG. 4D, a second insulating layer 232 is formed on the first insulating layer 231, and the second insulating layer 232 covers the winding spiral coil 22 and the magnetic pillar 25.

The second insulating layer 232 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

Furthermore, the second insulating layer 232 is formed on the first insulating layer 231 by molding, coating, or lamination, and the first insulating layer 231 and the second insulating layer 232 may jointly serve as a cladding layer 23. In addition, the first insulating layer 231 and the second insulating layer 232 may be made of the same or different materials, but the present disclosure is not limited as such.

As shown in FIG. 4E, the carrier board 20 is removed to expose the lower surfaces 21b of the at least two welding pads 21 from a lower surface of the first insulating layer 231.

As shown in FIG. 4F, a surface treatment process is performed to form a surface treatment layer 24 on the lower surfaces 21b of the at least two welding pads 21, followed by a singulation process to obtain the inductor structure 4 of the present disclosure.

The surface treatment layer 24 may be formed on the lower surfaces 21b of the at least two welding pads 21 by electroplating. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the manufacturing method of the inductor structure of the present disclosure employs an IC carrier board process combined with a winding spiral coil. The winding spiral coil, the magnetic pillar, and the welding pads are covered by the first insulating layer and the second insulating layer to form an integrated structure. The resulting inductor structure does not generate noise under high-current/high-frequency operations. The inductance/resistance values can be adjusted by selecting suitable types of winding spiral coil (e.g., copper wire) for winding according to requirements, thereby facilitating various designs and applications.

The present disclosure further provides an inductor structure 2, which comprises: at least two welding pads 21, a winding spiral coil 22, a cladding layer 23, and a surface treatment layer 24.

Each of the welding pads 21 has an upper surface 21a and a lower surface 21b opposing the upper surface 21a. Each of the welding pads 21 may, for example, be made of a metallic material such as copper or a solder material.

The winding spiral coil 22 has two opposite endpoints 221, which are respectively welded and fixed to the upper surfaces 21a of the at least two welding pads 21 and electrically connected thereto. The winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

The cladding layer 23 covers the winding spiral coil 22 and the at least two welding pads 21, and the lower surfaces 21b of the at least two welding pads 21 are exposed from the cladding layer 23. The cladding layer 23 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

The surface treatment layer 24 is bonded to the lower surfaces 21b of the at least two welding pads 21. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the inductor structure of the present disclosure can enable both the winding spiral coil and the welding pads to be covered in the cladding layer to form an integrated structure. The resulting inductor structure does not generate noise under high-current/high-frequency operations. In addition, the inductance/resistance values can be adjusted by selecting suitable types of winding spiral coil (e.g., copper wire) for winding according to requirements, thereby facilitating various designs and applications.

The present disclosure further provides an inductor structure 3, which comprises: at least two welding pads 21, a magnetic pillar 25, a winding spiral coil 22, a cladding layer 23, and a surface treatment layer 24.

Each of the welding pads 21 has an upper surface 21a and a lower surface 21b opposing the upper surface 21a. Each of the welding pads 21 may, for example, be made of a metallic material such as copper or a solder material.

The magnetic pillar 25 is vertically disposed between the at least two welding pads 21. The magnetic pillar 25 is of a pillar structure. The material of the magnetic pillar 25 may be a magnetically permeable material including at least one of iron (Fe), nickel (Ni), cobalt (Co), manganese (Mn), or zinc (Zn), or a combination thereof, or may be an alloy metal such as NiFe, NiSe, or CoNiFe.

The winding spiral coil 22 encircles the magnetic pillar 25 and has two opposite endpoints 221, which are respectively welded and fixed to the upper surfaces 21a of the at least two welding pads 21 and electrically connected thereto. A body of the winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

The cladding layer 23 covers the winding spiral coil 22, the magnetic pillar 25, and the at least two welding pads 21, and the lower surfaces 21b of the at least two welding pads 21 and one end surface of the magnetic pillar 25 are exposed from the cladding layer 23. The cladding layer 23 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

The surface treatment layer 24 is bonded to the lower surfaces 21b of the at least two welding pads 21. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the inductor structure of the present disclosure can enable the winding spiral coil, the magnetic pillar, and the welding pads to be covered in the cladding layer to form an integrated structure. The resulting inductor structure does not generate noise under high-current/high-frequency operations. In addition, the inductance/resistance values can be adjusted by selecting suitable types of winding spiral coil (e.g., copper wire) for winding according to requirements, thereby facilitating various designs and applications.

The present disclosure further provides an inductor structure 4, which comprises: at least two welding pads 21, a magnetic pillar 25, a winding spiral coil 22, a first insulating layer 231, a second insulating layer 232, and a surface treatment layer 24.

Each of the welding pads 21 has an upper surface 21a and a lower surface 21b opposing the upper surface 21a. Each of the welding pads 21 may, for example, be made of a metallic material such as copper or a solder material.

The first insulating layer 231 covers the at least two welding pads 21, and the upper surfaces 21a and the lower surfaces 21b of the at least two welding pads 21 are exposed from the first insulating layer 231. The first insulating layer 231 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such.

The magnetic pillar 25 is vertically disposed on the first insulating layer 231 and in a region between the at least two welding pads 21. The magnetic pillar 25 is of a pillar structure. The material of the magnetic pillar 25 may be a magnetically permeable material including at least one of iron (Fe), nickel (Ni), cobalt (Co), manganese (Mn), or zinc (Zn), or a combination thereof, or may be an alloy metal such as NiFe, NiSe, or CoNiFe.

The winding spiral coil 22 is disposed on the first insulating layer 231 and encircles the magnetic pillar 25. In addition, the winding spiral coil 22 has two opposite endpoints 221, which are respectively welded and fixed to the upper surfaces 21a of the at least two welding pads 21 and electrically connected thereto. A body of the winding spiral coil 22 is formed of copper wire, copper alloy wire, enameled copper wire, enameled copper alloy wire, enameled aluminum wire, or enameled alloy wire. The number of turns of the winding spiral coil 22 and the type of the winding spiral coil 22 (e.g., copper wire) may be designed and selected according to required inductance and/or resistance values, and the winding spiral coil 22 may be prefabricated, for example, as a pre-wound coil, by a winding machine.

The second insulating layer 232 is formed on the first insulating layer 231 and covers the winding spiral coil 22 and the magnetic pillar 25. The second insulating layer 232 may be made of a magnetic insulating material. For example, the magnetic insulating material may be a magnetically permeable material formed by combining iron-nickel-molybdenum alloy powder, iron-silicon-aluminum alloy powder, or iron-nickel alloy powder with a resin material. The resin material may be a non-photosensitive dielectric material, such as bismaleimide triazine (BT), FR5 (FR stands for flame retardant), Ajinomoto Build-up Film (ABF) (with or without glass fiber), or epoxy molding compound (EMC). Alternatively, the resin material may be a photosensitive dielectric material, such as solder resist or polyimide (PI), but the present disclosure is not limited as such. The first insulating layer 231 and the second insulating layer 232 may jointly serve as a cladding layer 23.

The surface treatment layer 24 is bonded to the lower surfaces 21b of the at least two welding pads 21. The material of the surface treatment layer 24 may be, for example, nickel/gold (Ni/Au), nickel/silver (Ni/Ag), nickel/tin (Ni/Sn), nickel/palladium/gold (Ni/Pd/Au), solder material, or organic solderability preservative (OSP).

In summary, the inductor structure of the present disclosure can enable the winding spiral coil, the magnetic pillar, and the welding pads to be covered by the first insulating layer and the second insulating layer to form an integrated structure. The resulting inductor structure does not generate noise under high-current/high-frequency operations. In addition, the inductance/resistance values can be adjusted by selecting suitable types of winding spiral coil (e.g., copper wire) for winding according to requirements, thereby facilitating various designs and applications.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. A method of manufacturing an inductor structure, comprising:
forming at least two welding pads on a carrier board by electroplating by means of a patterned exposure and development process;
disposing a winding spiral coil on upper surfaces of the at least two welding pads, wherein two endpoints of the winding spiral coil are electrically connected to the at least two welding pads, respectively, and a body of the winding spiral coil is formed of a copper wire or a copper alloy wire;
forming a cladding layer on the carrier board to cover the winding spiral coil and the at least two welding pads; and
removing the carrier board to expose lower surfaces of the at least two welding pads from the cladding layer.

2. The method of claim 1, wherein after forming the at least two welding pads by electroplating and before disposing the winding spiral coil, another patterned exposure and development process is performed to form a vertically oriented magnetic pillar on the carrier board and in a region between the at least two welding pads by electroplating.

3. The method of claim 1, wherein after forming the at least two welding pads by electroplating and before disposing the winding spiral coil, a first insulating layer covering the carrier board and the at least two welding pads is first formed, and a portion of the first insulating layer is then removed to expose the upper surfaces of the at least two welding pads.

4. The method of claim 3, wherein after forming the first insulating layer and exposing the upper surfaces of the at least two welding pads, another patterned exposure and development process is subsequently performed to form a vertically oriented magnetic pillar on the first insulating layer and in a region between the at least two welding pads by electroplating.

5. The method of claim 4, wherein after forming the magnetic pillar, the winding spiral coil is disposed on the upper surfaces of the at least two welding pads and the first insulating layer, the winding spiral coil encircles the magnetic pillar, a second insulating layer is subsequently formed on the upper surfaces of the at least two welding pads and the first insulating layer to cover the winding spiral coil and the magnetic pillar, and the first insulating layer and the second insulating layer jointly serve as the cladding layer.

6. The method of claim 1, wherein the cladding layer is made of a magnetic insulating material.

7. The method of claim 1, wherein after removing the carrier board, a surface treatment process is performed to form a surface treatment layer on the lower surfaces of the at least two welding pads.

8. The method of claim 1, further comprising: respectively fixing the two endpoints of the winding spiral coil to the upper surfaces of the at least two welding pads by welding by means of a laser spot welding process.

9. An inductor structure, comprising:
at least two welding pads, wherein each of the at least two welding pads has an upper surface and a lower surface opposing the upper surface;
a winding spiral coil disposed on the upper surfaces of the at least two welding pads, wherein two endpoints of the winding spiral coil are electrically connected to the at least two welding pads, respectively, and a body of the winding spiral coil is formed of a copper wire or a copper alloy wire; and
a cladding layer covering the winding spiral coil and the at least two welding pads, wherein the lower surfaces of the at least two welding pads are exposed from the cladding layer.

10. The inductor structure of claim 9, further comprising: a magnetic pillar embedded within the cladding layer and vertically disposed between the at least two welding pads, wherein the winding spiral coil encircles the magnetic pillar.

11. The inductor structure of claim 10, wherein one end surface of the magnetic pillar is exposed from the cladding layer.

12. The inductor structure of claim 9, wherein the cladding layer comprises a first insulating layer and a second insulating layer, the first insulating layer covers the at least two welding pads, the upper surfaces and the lower surfaces of the at least two welding pads are exposed from the first insulating layer, and the second insulating layer is formed on the first insulating layer and covers the winding spiral coil.

13. The inductor structure of claim 12, further comprising: a magnetic pillar embedded within the second insulating layer and vertically disposed on the first insulating layer, wherein the winding spiral coil encircles the magnetic pillar.

14. The inductor structure of claim 9, further comprising: a surface treatment layer formed on the lower surfaces of the at least two welding pads.

15. The inductor structure of claim 9, wherein the cladding layer is made of a magnetic insulating material.
